(19) United States
(12) Patent Application Publication
(10) Pub. No.: US 2021/0200341 A1
(43) Pub. Date: Jul. 1, 2021

(54) MOVABLE PEN CAPS

(71) Applicant: HEWLETT-PACKARD DEVELOPMENT COMPANY, L.P., Houston, TX (US)

(72) Inventors: Derek KANAS, Houston, TX (US); Steven Lee TALIAFERRO, Houston, TX (US)

(73) Assignee: HEWLETT-PACKARD DEVELOPMENT COMPANY, L.P., Houston, TX (US)

(21) Appl. No.: 16/076,512

(22) PCT Filed: Apr. 19, 2017
(86) PCT No.: PCT/US17/28459

§ 371 Date: Aug. 8, 2018

(51) Int. Cl. G06F 3/0354; B43K 23/12

(52) U.S. Cl. CPC G06F 3/03545; B43K 23/12

(57) ABSTRACT

Example implementations relate to movable pen caps. In an example, an active electrostatic stylus (AES) includes a housing, a pen tip coupled to a sensor, and an integrated pen cap coupled to the housing. The pen cap is movable between a first locked position and a second distal position to enclose the pen tip in an internal volume of the integrated pen cap when the pen cap is located at the second distal position.

### BACKGROUND

An electronic device may allow a user to input commands via a number of different devices. The number of different devices may include a computer keyboard, a computer mouse, and a pen that can be mechanically and/or electronically coupled to the electronic device.

### BRIEF DESCRIPTION OF THE DRAWINGS

FIG. 1 illustrates an example of an apparatus including a movable pen cap according to the disclosure.

FIG. 2 illustrates an example of a system including a movable pen cap according to the disclosure.

FIG. 3 illustrates an example of an apparatus including a movable pen cap that is located at one position according to the disclosure.

FIG. 4 illustrates an example of an apparatus including a movable pen cap that is located at another position according to the disclosure.

FIG. 5 illustrates a flow diagram for an example of a method of according to the disclosure.

### DETAILED DESCRIPTION

An electronic pen (e.g., stylus) can be communicatively coupled to an electronic device and compatibly used with the electronic device. For example, the stylus can be utilized with the electronic device to select items, draw objects, and/or write letters on a display of the electronic device. The stylus (e.g., active electrostatic stylus) can include an internal power source to be utilized in an active manner. As used herein, the AES can refer to a stylus that includes the internal power source and that can be compatibly utilized with the electronic device. The AES contacts with the display of the electronic device via a pen tip, and the AES transmits the input received from the pen tip to the electronic device via a sensor to which the pen tip is coupled to. The internal power source of the AES is electrically coupled to the sensor such that the sensor is also utilized in an active manner. As such, utilizing the pen tip will activate the internal power source, and result in a drainage of the internal power source.

The AES may provide mechanisms to protect the pen tip. For example, the AES may include a removable cover that covers the pen tip and/or a spring that absorbs a portion of force (e.g., pressure) applied to the pen tip to some extent. However, even in such approaches, the AES does not completely protect the pen tip from an undesirable contact because the removable cover and the spring still allows the pen tip to be contacted and/or damaged.

The disclosure is directed to an AES and an AES system including a movable pen cap and method of enclosing a pen tip in an internal volume of the movable pen cap. Example implementations relate to movable pen caps. In an example, an AES includes a housing, a pen tip coupled to a sensor, and an integrated pen cap coupled to the housing. The pen cap is movable between a first locked position and a second distal position to enclose the pen tip in an internal volume of the integrated pen cap when the pen cap is located at the second distal position.

Notably, the AES including the movable pen cap, as described herein, can provide benefits such as protecting the pen tip and those components coupled to and/or affected along with the pen tip. For example, the AES including the movable pen cap can prevent an undesirable drainage of a power source (e.g., battery) of the AES and/or prevent a sensor (e.g., coupled to the pen tip) from being damaged.

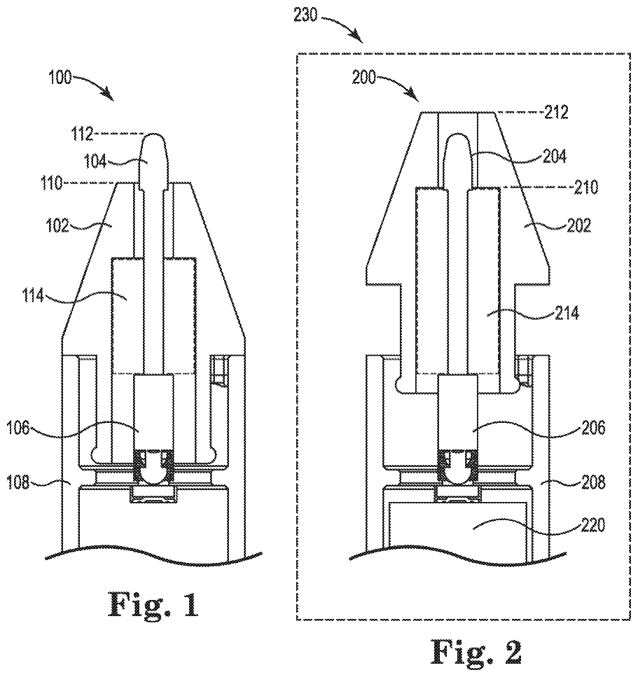

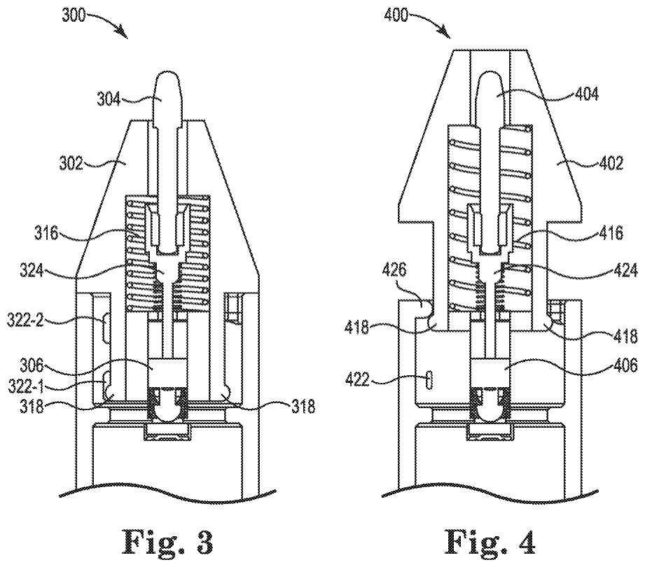

FIG. 1 illustrates an example of an apparatus 100 including a movable pen cap 102 according to the disclosure. In various examples, the AES 100 can comprise an integrated pen cap 102 (e.g., integrated to the AES 100), a pen tip 104 coupled to a sensor 106, and a housing 108. As used herein, the integrated pen cap can refer to a pen cap that is integrated to the AES. In various examples, the pen cap is integrated to the AES in a non-removable manner.

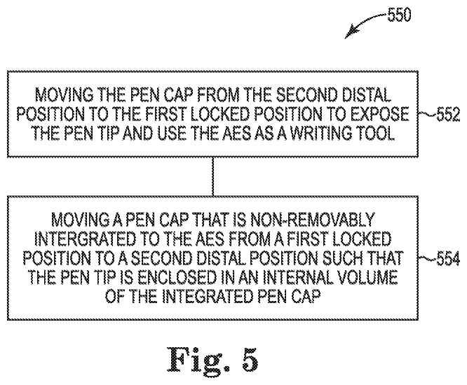

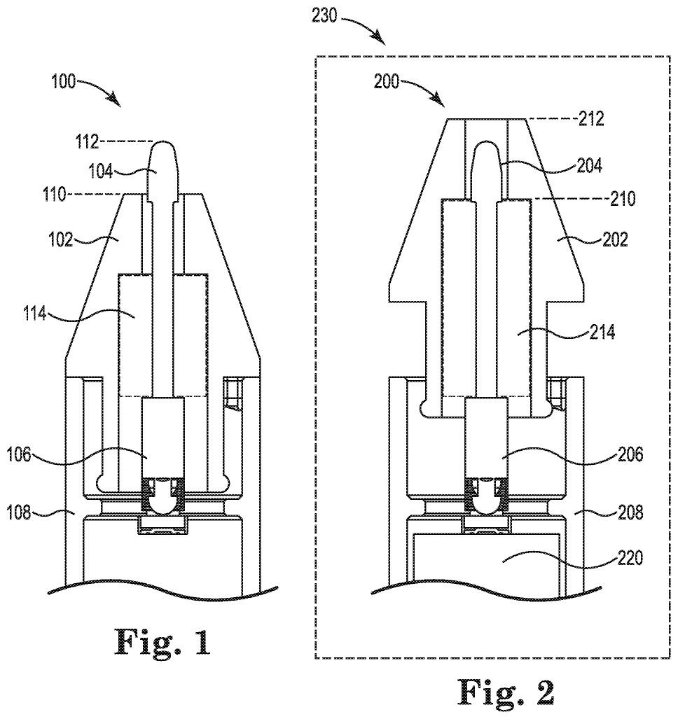

In various examples, the integrated pen cap 102 is movable between a first locked position and a second distal position to enclose the pen tip in an internal volume 114 of the integrated pen cap 102 when the pen cap 102 is located at the second distal position 112. As shown in FIG. 1, for example, the pen cap 102 can be located at the first locked position when an end of the pen cap 102 lies on a position 110. In some examples, the pen cap 102 is located at the second distal position when the end of the pen cap 102 lies on the position 112 (e.g., as shown in FIG. 2). In this example (e.g., when the pen cap 102 is located at the second distal position), the internal volume 114 of the pen cap 102 encloses the pen tip 104 that was previously exposed above the end of the pen cap 102 (e.g., as shown in FIG. 1).

By providing a mechanism to move the pen cap 102 between two different positions (e.g., first locked position and second distal position), the AES 100 of the disclosure can provide protection to the pen tip 104. For example, an user can move the pen cap 102 to the second distal position when the AES is not being used, and the pen cap 102 (e.g., located at the second distal position) that encloses the pen tip 104 in the internal volume 114 of the pen cap 102 protects the pen tip 104 from an undesirable contact when the AES 100 is not being used (e.g., the pen cap 102 can be moved to the second distal position when the AES 100 is not being used).

In various examples, the pen cap 102 is rotatable around the housing to unlock the pen cap 102 from the first locked position. For example, the pen cap 102 may be locked at a particular position (e.g., first locked position and/or second distal position) such that the pen cap 102 does not undesirably move between the first locked position and the second distal position when locked. In this example, rotating the pen cap 102 may dissolve a coupling between the pen cap 102 and the housing 108 such that the pen cap 102 is unlocked from the particular position.

In various examples, the pen cap is non-removably integrated to the AES. For example, the pen cap 102 may not be separated from the housing 108 while given a freedom to move, for example, between the first locked position (e.g., the end of the pen tip 102 lies on the position 110) and the second distal position (e.g., the end of the pen tip 102 lies on the position 112).

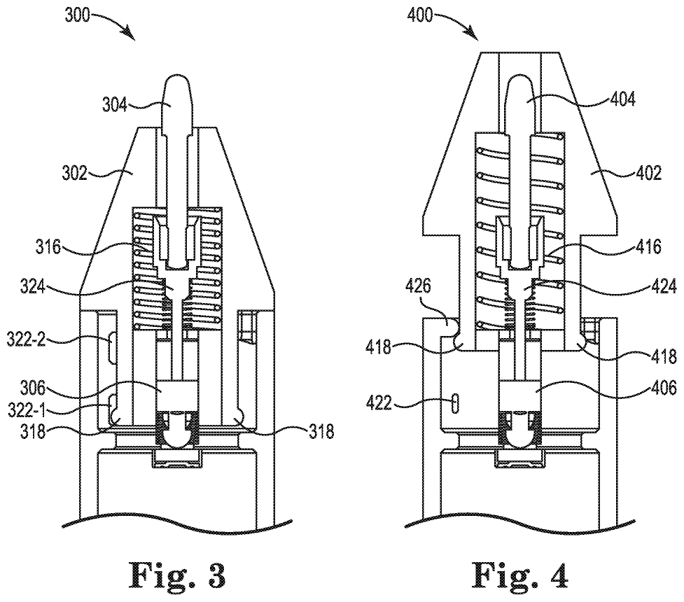

In various examples, the AES 100 can include a locking component that locks the pen cap 102 in a particular position (e.g., first locked position and second distal position). For example, the pen cap 102 can include an external thread, and the housing 108 can include an internal thread that can be readily coupled to the internal thread of the pen cap 102. Locking the pen cap 102 at a particular position via an internal, and an external thread is described further in connection with FIG. 3.

FIG. 2 illustrates an example of a system 230 including a movable pen cap 202 according to the disclosure. In various examples, the AES system 230 can comprise an AES 200 coupled to (e.g., Including) an internal power source 220. The AES 200 can include a pen cap 202 (e.g., integrated to the AES system 230), a pen tip 204 coupled to a sensor 206, and a housing 208. The pen cap 202, the pen tip 204, the sensor 206, and the housing 208 are analogous to those (e.g., pen cap 102, pen tip 104, sensor 106, and housing 108) described in FIG. 1. In various examples, the internal power source 220 can be a battery that can supply power to, for example, the sensor 206.

In various examples, the integrated pen cap 202 coupled to the housing 208 is movable between a first locked position and a second distal position that are relative to the housing 208. For example, as shown in FIG. 2, an end of the pen cap 202 lies on a position 212, and therefore, is located at the second distal position. The pen cap 202 located at the second distal position encloses the pen tip 204 in an internal volume 214 of the pen cap 202.

Enclosing the pen tip 204 in the internal volume 214 of the integrated pen cap 202 provides benefits such as preventing an undesirable drainage of the internal power source 220, among various other benefits. For example, the AES system 230 that is not being used may be exposed to various undesirable contacts and/or damages. For example, the AES 200 system can be dropped on the pen tip 204 such that the pen tip 204 is undesirably contacted. Such an undesirable contact of the pen tip 204 can activate the AES system 230, which will result in the undesirable drainage of the internal power source 220. In contrast to other approaches that does not provide complete enclosure of the pen tip 204, the AES system 230 of the disclosure can prevent the pen tip 204 from being undesirably contacted (e.g., used). As such, the AES system 230 of the disclosure can prevent the undesirable drainage of the internal power source 220.

In various examples, the pen cap 202 can be unlocked from the second distal position, and moved to the first locked position such that an end of the pen cap 202 lies on the position 210. In this example, the pen tip 204 is exposed above the end of the pen cap 202 (e.g., when the pen cap 202 is moved to the first locked position) such that the AES 200 system can be used as a writing tool.

In various examples, the sensor 206 can be a pressure sensor. For example, the pressure sensor (e.g., sensor 206) may detect a degree of pressure applied to the pressure sensor 206 via the pen tip 204. In various examples, the AES system 230 may include other components such as a communicating module (not shown) that generates a signal (e.g., encoded signal that can be decoded by a client device) based on an output from the sensor 206, and transmits the signal to a client device (e.g., smartphone, tablet, PC, etc.) that the AES system 230 is communicatively coupled to.

In various examples, since the sensor 206 is coupled to the pen tip 204, excessive force (e.g., pressure) applied to the pen tip 204 may damage the sensor 206 (e.g., pressure sensor). As such, protecting the pen tip 204 from an undesirable contact by enclosing the pen tip 204 in the pen cap 202 can further provide benefits such as protecting the sensor 206 from being damaged.

In various examples, the pen tip 204 and the sensor 206 are non-movably coupled to the housing 208, and the integrated pen cap 202 can be movably integrated to the housing 208. For example, while the pen cap 202 can be movable (e.g., between the first locked position and the second distal position) respective to the housing 208, the pen tip 204 and the sensor 206 are non-movably coupled to the housing 208 such that the pen tip 204 and the sensor 206 are not movable respective to the housing 208.

FIG. 3 illustrates an example of an apparatus 300 including a movable pen cap 302 that is located at one position according to the disclosure. The AES 300 as shown in FIG. 3 comprises a pen cap 302 (e.g., integrated to the AES 300), a pen tip 304 coupled to a sensor 306, a spring 318, and an intermediate connector 324. The pen cap 302 can include an external thread 318, and the housing 308 can include an internal thread 322. The AES 300, the pen cap 302, the pen tip 304, and the sensor 306 are analogous to those described in FIGS. 1 and 2. In various examples, the AES 300 includes the intermediate connector 324, and the pen tip 302 can be coupled to the sensor 306 via the intermediate connector 324, as shown in FIG. 3.

In various examples, the external thread 318 (e.g., of the pen cap 302) can be coupled to the internal thread 322 (e.g., of the housing 308) to lock the pen cap 320 in a particular position (e.g., first locked position and/or second distal position as described in FIGS. 1 and 2). The housing 308 can include a first internal thread (e.g., 322-1) and a second internal thread (e.g., 322-2) each corresponding to the first locked position and the second distal position, respectively. For example, the housing 308 may include two internal threads 322-1 and 322-2 that the external thread 318 can be coupled to. The external thread 318 can be coupled to the internal thread 322-1 to lock the pen cap 302 in the first locked position, and to the internal thread 322-2 to lock the pen cap 302 in the second distal position. As shown in FIG. 3, the external thread 318 is coupled to the internal thread 322-1; therefore, the pen cap 302 is located at the first locked position. The pen cap 302 (e.g., that is rotatable around the housing 308) can be rotated around the housing 308 to unlock the pen cap 302 that is locked at a particular position (e.g., first locked position or second distal position).

In various examples, the AES 300 includes the spring 316 disposable against the inner surface of the pen cap 302 to move the pen cap 302 to the second distal position (e.g., as shown in FIG. 4) when the pen cap 302 is unlocked from the first locked position 330. For example, when the pen cap 302 is located at the first locked position 330, the spring that is coupled to the inner surface of the pen cap 302 is in a compressed state. As such, when the pen cap 302 is, for example, unlocked from the first locked position (e.g., by rotating the pen cap 302 around the housing 308), the spring 316 can push the pen cap 302 to its second distal position as the spring 316 restores its original state/shape from the compressed state, as shown in FIG. 4.

FIG. 4 illustrates an example of an apparatus 400 including a movable pen cap 402 that is located at another position according to the disclosure. The AES 400 shown in FIG. 4 is analogous to the AES 300 described in FIG. 3. For example, a pen cap 402, a pen tip 404, a sensor 406, and a spring 416 are analogous to the pen cap 302, the pen tip 304, the sensor 306, and the spring 316 as shown in FIG. 3. The pen tip 404 can be coupled to the sensor 406 via an intermediate connector 426.

As shown in FIG. 4, the housing 408 can include an internal thread 422 that is analogous to the internal thread 322-1. As described herein, the external thread 418 can be coupled to the internal thread 422 to lock the pen cap 402 in the first locked position. As shown in FIG. 4, the external thread 418 is not coupled to the internal thread 422; therefore, the pen cap 402 is located at the second distal position.

In various examples, the AES 400 includes the spring 416 disposable against the inner surface of the pen cap 402 to move the pen cap 402 to the second distal position (e.g., as shown in FIG. 4) when the pen cap 402 is unlocked from the first locked position. For example, when the pen cap 402 is unlocked from the first locked position (e.g., where the pen cap 302 is located as shown in FIG. 3), the spring 416 that is coupled to the pen cap 402 can push the pen cap 402 to the second distal position (e.g., where the pen cap 402 is located as shown in FIG. 4) as the spring 416 restores its original state/shape.

In some examples, the AES 400 may not include a locking component (e.g., internal and external threads) that locks the pen cap 402 in the second distal position. Instead, the spring 416 may protect the pen tip 404 from an undesirable contact by constantly pushing the pen cap 402 in a particular direction (e.g., in a direction from the first locked position to the second distal position). For example, the spring 416 can dampen (e.g., weaken) an impact caused by, for example, dropping the AES 400 on the pen cap 402 by providing force against the impact. As such, the force provided by the spring 416 can prevent the pen cap 402 from undesirably moving in a direction toward the first locked position (e.g., in which the pen tip 404 can be undesirably exposed above the pen cap 402). Therefore, the AES 400 that does not lock the pen cap 402 at the second distal position can still protect the pen tip 404 from the undesirable contact. In some examples where the AES 400 does not lock the pen cap 402 in the second distal position, the housing 408 may include a particular feature 426 that prevents the spring 416 from pushing the pen cap 402 beyond the second distal position.

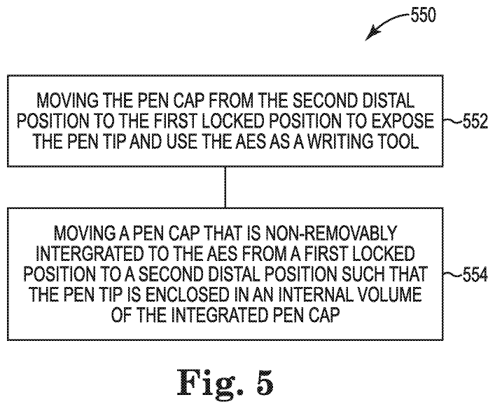

FIG. 5 illustrates a flow diagram for an example of a method 550 of according to the disclosure. At 552, the method 550 can include moving the pen cap from the second distal position to the first locked position to expose the pen tip and use the AES as a writing tool. At 554, the method 550 can include moving a pen cap that is non-removably integrated to an active electrostatic stylus (AES) from a first locked position to a second distal position such that the pen tip is enclosed in an internal volume of the integrated pen cap.

In various examples, the method 550 can include moving the pen cap independently respective to the pen tip. For example, the pen cap can be movably coupled to a housing (e.g., housing 108, 208, 308, and/or 408) while the pen tip can be non-movably coupled to the housing. As such, the pen cap moves respective to the housing while the pen tip is fixed (e.g., does not move respective to the housing). As such, the pen cap can be moved independently respective to the pen tip.

In some examples, the method 550 can include locking the pen cap in a particular position including the first locked position and the second distal position to prevent the pen cap from undesirably moving between the first locked position and the second distal position. For example, the AES can include a locking component that can be external and internal threads (e.g., 318 and 322 as described in FIG. 4). In this example, the housing (e.g., 308) can include a first (e.g., 322-1) and a second (322-2) internal threads each corresponding to the first locked position and the second distal position, respectively. As such, the external thread (e.g., 318) of the pen cap (e.g., 302) can be coupled to the first internal thread (e.g., 322-1) to lock the pen cap 402 at the first locked position, and coupled to the second internal thread (e.g., 322-2) to lock the pen cap (e.g., 302) at the second distal position.

In some examples, the method 550 can include rotating the pen cap around a housing (e.g., 108, 208, 308, and/or 408) to unlock the pen cap from a particular position including the first position and the second position. For example, the AES can include a locking component (e.g., external and internal threads 318 and 322 as described in FIG. 4) that is activated or inactivated by rotating the pen cap (e.g., 302), for example, respective to the housing.

Since many examples can be made without departing from the spirit and scope of the system and method of the disclosure, this specification merely sets forth some of the many possible example configurations and implementations. In the disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. An active electrostatic stylus (AES), comprising:
a housing;
a pen tip coupled to a sensor; and
an integrated pen cap coupled to the housing, wherein the pen cap is movable between a first locked position and a second distal position to enclose the pen tip in an internal volume of the integrated pen cap when the pen cap is located at the second distal position.

2. The AES of claim 1, wherein the pen cap is rotatable around the housing to unlock the pen cap from the first position.

3. The AES of claim 1, wherein the pen cap is non-removably integrated to the AES.

4. The AES of claim 1, wherein the AES includes a locking component that locks the pen cap in a particular position including the first position and the second position.

5. An active electrostatic stylus (AES) system, comprising:
a housing;
a pen tip coupled to a sensor;
an internal power source to supply power to the sensor; and
an integrated pen cap coupled to the housing and movable between a first locked position and a second distal position that are relative to the housing, wherein the pen cap is moved to the second distal position to enclose the pen tip in an internal volume of the integrated pen cap.

6. The system of claim 5, wherein the integrated pen cap includes an external thread that is coupled to an internal thread of the housing to lock the integrated pen cap in a particular position including the first locked position and the second distal position.

7. The system of claim 6, wherein the housing includes a first internal thread and a second internal thread, wherein the first internal thread corresponds to the first locked position and the second internal thread corresponds to the second distal position.

8. The system of claim 5, wherein the AES system includes an intermediate connector, and wherein the pen tip is coupled to the sensor via the intermediate connector.

9. The system of claim 5, wherein the pen tip and the sensor are non-movably coupled to a housing, and wherein the integrated pen cap is movably integrated to the housing.

10. The system of claim 5, wherein the AES system includes a spring disposable against the inner surface of the integrated pen cap to move the integrated pen cap to the second distal position when the integrated pen cap is unlocked from the first locked position.

11. The system of claim 5, wherein the sensor is a pressure sensor.

12. A method, comprising:
moving the pen cap from the second distal position to the first locked position to expose the pen tip and use the AES as a writing tool; and
moving a pen cap that is non-removably integrated to an active electrostatic stylus (AES) from a first locked position to a second distal position such that the pen tip is enclosed in an internal volume of the integrated pen cap.

13. The method of claim 11, including moving the pen cap independently respective to the pen tip.

14. The method of claim 11, including rotating the pen cap around a housing to unlock the pen cap from a particular position including the first position and the second position.

15. The method of claim 11, including locking the pen cap in a particular position including the first locked position and the second distal position to prevent the pen cap from undesirably moving the first locked position and the second distal position.
